(19) United States
(12) Patent Application Publication
(10) Pub. No.: US 2025/0117006 A1
(43) Pub. Date: Apr. 10, 2025

(54) SYSTEMS AND METHODS OF REMOTE DYNAMIC VISUALIZATION OF SITUATIONS TO BE NAVIGATED BY AUTONOMOUS VEHICLES

(71) Applicant: Torc Robotics, Inc., Blacksburg, VA (US)

(72) Inventor: Brett Hutton, Blacksburg, VA (US)

(21) Appl. No.: 18/484,210

(22) Filed: Oct. 10, 2023

(51) Int. Cl. G05D 1/00

(52) U.S. Cl. CPC G05D 1/0044

(57) ABSTRACT

An autonomous vehicle is provided. The autonomous vehicle includes one or more sensors and an autonomous driving computing device. The autonomous driving computing device includes at least one processor in communication with at least one memory device. The at least one processor is programmed to process sensor data received from the one or more sensors, render the processed sensor data into 3D images, convert the 3D images into a video stream, and transmit, via mobile communication, the video stream to a remote user.

### TECHNICAL FIELD

The field of the disclosure relates generally to autonomous vehicles and, more specifically, visualization of situations to be navigated by autonomous vehicles.

### BACKGROUND OF THE INVENTION

The use of autonomous vehicles has become increasingly prevalent in recent years. One challenge faced by autonomous vehicles is the development of systems that provide remote, dynamic visualization of situations that will need to be successfully navigated by autonomous vehicles. Some aspects of known methods and systems have associated shortcomings. The shortcomings generally include low resolution, low speed, and lack of capability to facilitate manipulation by a user. As a result in order to ensure that autonomous vehicles can successfully navigate roadway situations, improvements to known systems are required.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed autonomous vehicle includes one or more sensors and an autonomous driving computing device. The autonomous driving computing device includes at least one processor in communication with at least one memory device. The at least one processor is programmed to process sensor data received from the one or more sensors, render the processed sensor data into 3D images, convert the 3D images into a video stream, and transmit, via mobile communication, the video stream to a remote user.

In another aspect, the disclosed autonomous driving computing device includes at least one processor in communication with at least one memory device. The at least one processor is programmed to process sensor data received from one or more sensors of an autonomous vehicle, render the processed sensor data into 3D images, convert the 3D images into a video stream, and transmit, via mobile communication, the video stream to a remote user.

In yet another aspect, the disclosed one or more non-transitory machine-readable storage media for manipulating visualization of sensor data of an autonomous vehicle include a plurality of instructions stored thereon. The plurality of instructions, in response to being executed, cause a system to receive, via mobile communication, a video stream sent from an autonomous vehicle. The video stream is generated by processing sensor data received from one or more sensors of the autonomous vehicle, rendering the processed sensor data into 3D images, and converting the 3D images into the video stream.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1A is a schematic diagram of an autonomous vehicle;

FIG. 1B is a schematic diagram of an environment of an autonomous vehicle when traveling;

FIG. 1C is a block diagram of the autonomous driving system;

FIG. 2A is a schematic diagram of an example visualization system;

FIG. 2B is a block diagram of the visualization system;

FIG. 2C is a flow chart of an example method of visualization;

FIG. 3 is a screenshot of a video stream;

FIG. 4 is a block diagram of an exemplary computing device; and

FIG. 5 is a block diagram of an exemplary server computing device.

Corresponding reference characters indicate corresponding parts throughout the several views of the drawings. Although specific features of various examples may be shown in some drawings and not in others, this is for convenience only. Any feature of any drawing may be reference or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

While this disclosure uses a truck (e.g., a semi-truck) as an example of the autonomous vehicle for illustration purposes only, it is understood that the autonomous vehicle may be any type of vehicle including but not limited to an automobile, a mobile industrial machine, a train, a bus, an aerial vehicle, or a water vehicle. While the disclosure will discuss a self-driving or driverless autonomous vehicle, it is understood that the autonomous vehicle could alternatively be semi-autonomous, having varying degrees of autonomy or autonomous functionality.

The amount of data from sensors on an autonomous vehicle may be in the rate of 1 terabyte or more per hour. Typical cellular bandwidth is in the range of kilobytes per second, especially in remote areas. The cellular bandwidth is sufficient to view video streams at a relatively low quality such as at a relatively low resolution and/or a relatively low refreshing rate. As used herein, a video stream includes a stream of videos or static images. The cellular bandwidth, however, is insufficient to transmit the sensor data or a 3D rendered volume stream in real time.

In known methods, a remote user is provided with images of fixed and/or predefined views. The visualization system does not provide any option or capability for the remote user to change the views or select sources of data for the images, limiting the visualization of the situations of the autonomous vehicle. Due to the limitation of cellular bandwidth, a user needs to be in the autonomous vehicle to view and/or change the views or sources from a computing device directly connected with the computer of the autonomous vehicle, or alternatively view from the computer of the autonomous vehicle itself, which greatly limits the applications of remote access. Further, a computing device needs to have the required computing power to process the sensor data and perform 3D rendering, especially 3D rendering of LiDAR data, placing a limit on the computing devices a remote user can use. In some known methods, sensor data are reduced in quality to the level that can be transmitted via cellular communication. As a result, the presented images possess poor quality, and the known systems are unable to use the high-quality data provided by sensors. As used herein, cellular communication refers to communication via cellular networks, where signals are transmitted and/or received over cellular networks. A cellular network is a telecommunications network that links nodes wirelessly.

In contrast, in the systems and methods described herein, an autonomous driving computing device of the autonomous vehicle processes the sensor data and renders the processed sensor data into 3D images. The 3D images are converted into a video stream to be transmitted to a remote user via cellular communication. The resolution and refreshing rate of the video stream may be selected to be relatively low such that the data of the video stream is in the range of cellular bandwidth, such as in the range of kilobytes per second. The high-quality data is processed and rendered directly by autonomous driving computing device 104, thereby providing high quality visualization to remote users without any limitation from bandwidth in data transmission. The video streams have relatively low latency, because the 3D rendered images have been converted to image/video streams of a much smaller data size than the 3D rendered images and/or sensor data. A remote user is also provided with functionalities of manipulating the visualization, such as manipulating the display and/or selecting sources of sensor data. Systems and methods described herein are advantageous in providing the flexibility and responsiveness in manipulating and visualization without a compromise to the quality of the video stream or the need to sacrifice the quality of sensor data in order to accommodate the low bandwidth of cellular communication.

Cellular communication is described as an example for illustration purposes only. Systems and methods described herein may be applied to mobile communication in general. Mobile communication includes cellular communication, satellite communication, and a combination thereof.

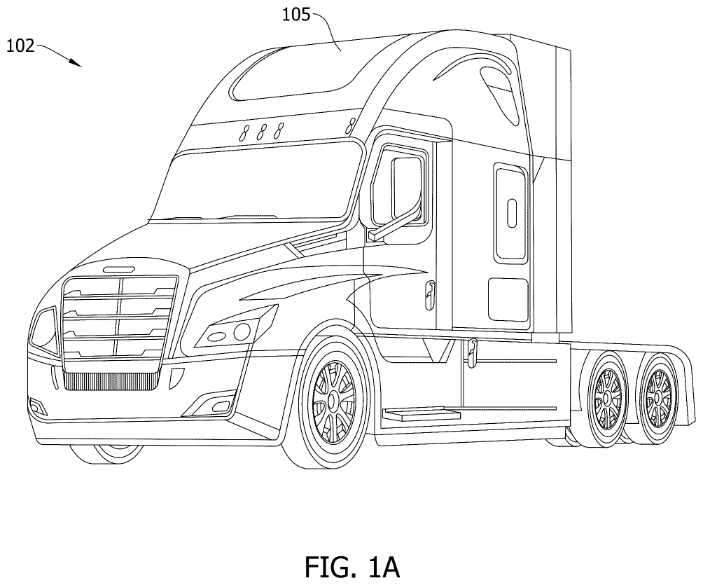

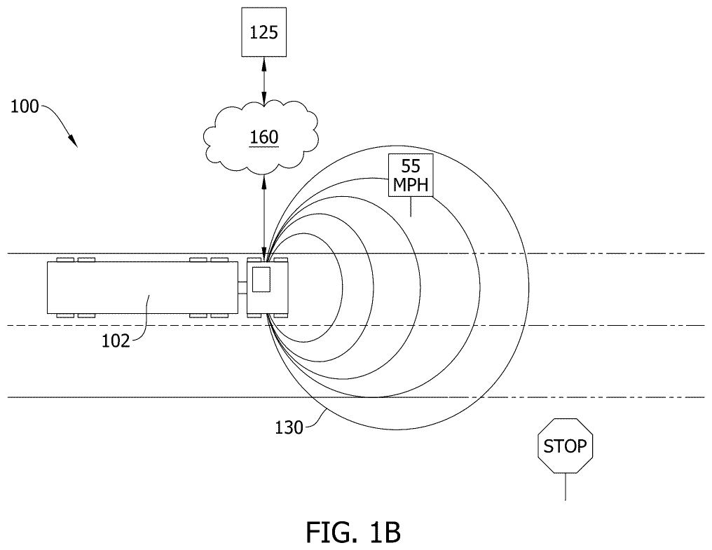

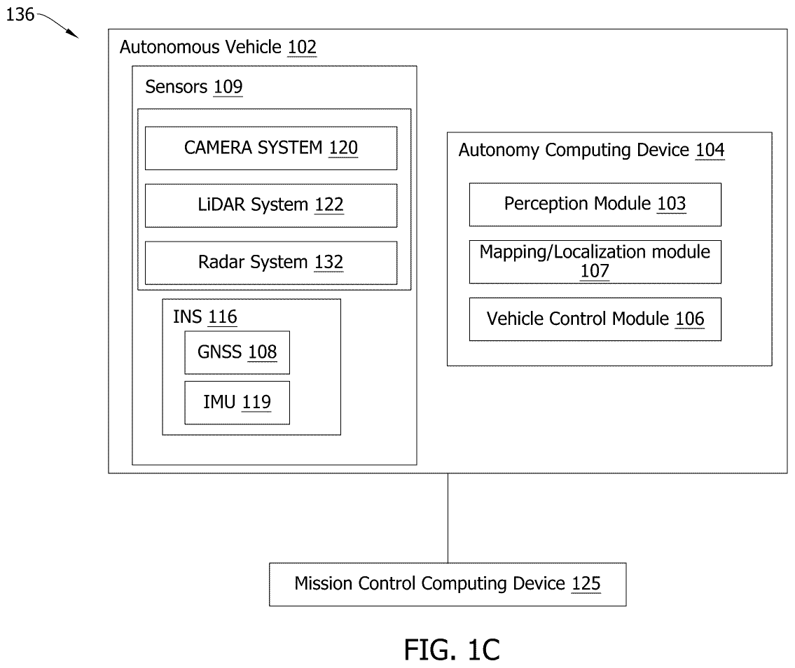

FIGS. 1A-1C show an autonomous vehicle 102 and associated autonomous driving system 136. FIG. 1A is a schematic diagram of autonomous vehicle 102. FIG. 1B shows an environment of an autonomous vehicle when traveling. FIG. 1C is a block diagram of an autonomous driving system 136.

In the example embodiment, autonomous vehicle 102 is a semi-truck, which may be further connected to a single or tandem trailer to transport the trailers along with the cargo inside to a desired location. Autonomous vehicle 102 includes a tractor 105. The tractor 105 includes an autonomous driving system 136 which further includes a computing device 104 (see FIG. 1C).

In the exemplary embodiment, autonomous driving computing device 104 includes modules and submodules to perform certain functions. The modules and submodules of autonomous driving computing device 104 may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 102.

In the exemplary embodiment, autonomous driving computing device 104 may be structured to provide focused analysis in at least three segments of functionality: (1) perception, (2) localization, and (3) planning/control. The focus of the perception functionality is to sense an environment surrounding autonomous vehicle 102 and interpret the environment. To interpret the surrounding environment, a perception module or engine 103 in autonomous driving computing device 104 may identify and classify objects or groups of objects in the environment. For example, a perception module associated with various sensors (e.g., LiDAR, camera, radar, etc.) of autonomous driving computing device 104 may identify one or more objects (e.g., pedestrians, vehicles, debris, etc.) and features of the roadway (e.g., lane lines) around autonomous vehicle 102 and distinctly classify the objects in the road.

In the example embodiment, the localization aspect of autonomous driving computing device 104 may be configured to determine where on a pre-established digital map autonomous vehicle 102 is currently located. One way to accomplish localization is to sense the environment surrounding autonomous vehicle 102 (e.g., via the perception system) and to correlate features of the sensed environment with details (e.g., digital representations of the features of the sensed environment) on the digital map.

In the exemplary embodiment, once the systems on autonomous vehicle 102 have determined the autonomous vehicle's location with respect to the digital map features (e.g., location on the roadway, upcoming intersections, road signs, etc.), autonomous vehicle 102 can plan and execute maneuvers and/or routes with respect to the features of the digital map. The planning/control aspects of the autonomous driving computing device 104 is configured to make decisions about how autonomous vehicle 102 should move through the environment to get to the goal or destination of autonomous vehicle 102. Autonomous driving computing device 104 may consume information from the perception and localization modules to determine where autonomous vehicle 102 is located relative to the surrounding environment and understand what other objects and moving traffic are located in the environment and their associated behaviors.

FIG. 1B illustrates an example environment 100 of autonomous vehicle 102 when the autonomous vehicle is in operation and moving. Autonomous vehicle 102 is capable of communicatively coupling to a remote mission control computing device 125 via a network 160. Autonomous vehicle 102 may not necessarily connect with network 160 or mission control computing device 125 while it is in operation (e.g., driving down the roadway), where mission control computing device 125 may be remote from the vehicle, and autonomous vehicle 102 may deploy with all the necessary perception, localization, and vehicle control software and data necessary to complete the mission fully-autonomously or semi-autonomously.

In the example embodiment, autonomous vehicle 102 includes a perception system including a camera system 120, a LiDAR system 122, a radar system 132, an inertial navigation system (INS) 116, and/or a perception module 103. Besides perception module 103, autonomous driving computing device 104 may further include a mapping/localization module 107 and a vehicle control module 106. The various systems may serve as inputs to and receive outputs from various other components of autonomous driving computing device 104. In other examples, autonomous driving computing device 104 may include more, fewer, or different components or systems, and each of the components or system(s) may include more, fewer, or different components. Additionally, the systems and components shown may be combined or divided in various ways. As shown in FIG. 1B, the perception systems aboard the autonomous vehicle help autonomous vehicle 102 perceive its environment out to a perception radius 130. The actions of autonomous vehicle 102 may depend on the extent of perception radius 130.

In the example embodiment, camera system 120 of the perception system includes one or more cameras mounted at any location on autonomous vehicle 102, which are configured to capture images of the environment surrounding autonomous vehicle 102 in any aspect or field of view (FOV). The FOV can have any angle or aspect such that images of the areas ahead of, to the side, and behind autonomous vehicle 102 may be captured. In some embodiments, the FOV may be limited to particular areas around autonomous vehicle 102 (e.g., ahead of autonomous vehicle 102) or may surround 360 degrees of autonomous vehicle 102. In some embodiments, the image data generated by camera system(s) 120 are sent to perception module 103 and stored, for example, in a memory.

In the exemplary embodiment, radar system 132 estimates strength or effective mass of an object. Radar system 132 may be based on 24 GHz, 77 GHz, or other frequency radio waves. Radar system 132 may include short-range radar (SRR), mid-range radar (MRR), or long-range radar (LRR). One or more sensors may emit radio waves, and a processor processes received reflected data (e.g., raw radar sensor data).

In the exemplary embodiment, LiDAR system 122 includes a laser generator and a detector and can send and receive laser range finding. The individual laser points can be emitted to and received from any direction such that LiDAR point clouds (or “LiDAR images”) of the areas ahead of, to the side of, and behind autonomous vehicle 102 can be captured and stored. In some embodiments, autonomous vehicle 102 may include multiple LiDAR systems, and point cloud data from the multiple systems may be fused together. In some embodiments, the system inputs from camera system 120 and LiDAR system 122 may be fused (e.g., in perception module 103). LiDAR system 122 may include one or more actuators to modify a position and/or orientation of LiDAR system 122 or components thereof. LIDAR system 122 may be configured to use ultraviolet (UV), visible, or infrared light to image objects and can be used with a wide range of targets. In some embodiments, LiDAR system 122 can be used to map physical features of an object with high resolution (e.g., using a narrow laser beam). In some examples, LiDAR system 122 may generate a point cloud, and the point cloud may be rendered to visualize the environment surrounding autonomous vehicle 102 (or object(s) therein). In some embodiments, the point cloud may be rendered as one or more polygon(s) or mesh model(s) through, for example, surface reconstruction. Collectively, LiDAR system 122 and camera system 120 may be referred to herein as “imaging systems.”

In the exemplary embodiment, inertial navigation system (INS) 116 is configured to determine spatial properties such as the location, orientation, and velocity of autonomous vehicle 102. INS 116 may include a global navigation satellite system (GNSS) 108 configured to provide positioning, navigation, and timing using satellites. INS 116 also includes an inertial measurement unit (IMU) 119 configured to measure motion properties such as the velocity and acceleration of autonomous vehicle 102. GNSS 108 is positioned on autonomous vehicle 102 and is configured to determine a location of autonomous vehicle 102 via GNSS data. GNSS 108 may be configured to receive one or more signals from a system such as a global position system (GPS) to localize autonomous vehicle 102 via geolocation. GNSS 108 may provide an input to and otherwise communicate with mapping/localization module 107. The communication between GNSS 108 and module 107 provides location data for use with one or more digital maps, such as a high definition (HD) map (e.g., in a vector layer, in a raster layer or other semantic map, etc.). In some embodiments, GNSS 108 may be configured to receive updates from an external network.

In the exemplary embodiment, IMU 119 is an electronic device that measures and reports one or more features regarding the motion of autonomous vehicle 102. For example, IMU 119 may measure a velocity, an acceleration, an angular rate, and/or an orientation of autonomous vehicle 102 or one or more of individual components in the features using a combination of accelerometers, gyroscopes, and/or magnetometers. IMU 119 may detect linear acceleration using one or more accelerometers and rotational rate using one or more gyroscopes. In some embodiments, IMU 119 may be communicatively coupled to GNSS 108 and/or mapping/localization module 107, to help determine a real-time location of autonomous vehicle 102 and predict a location of autonomous vehicle 102 even when GNSS 108 cannot receive satellite signals.

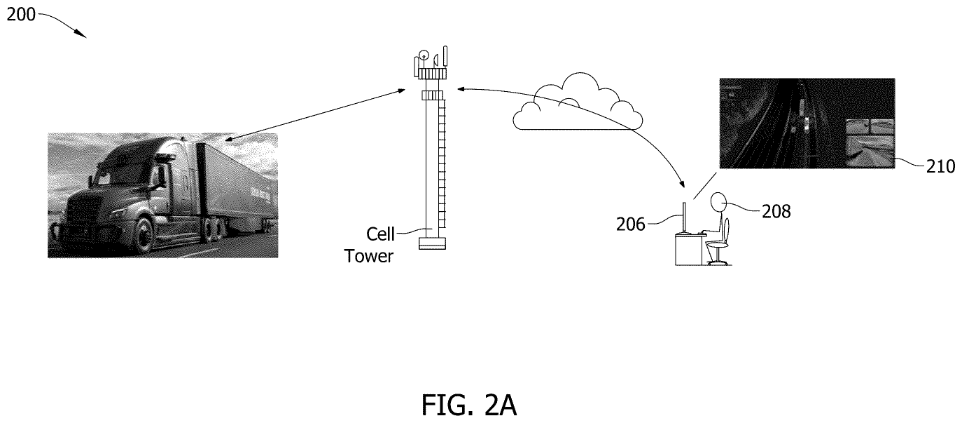

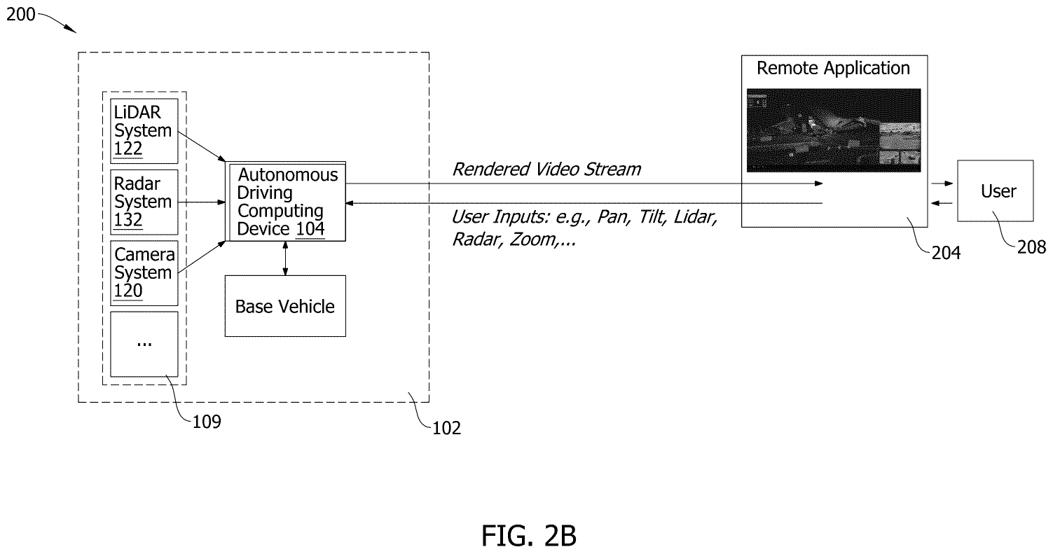

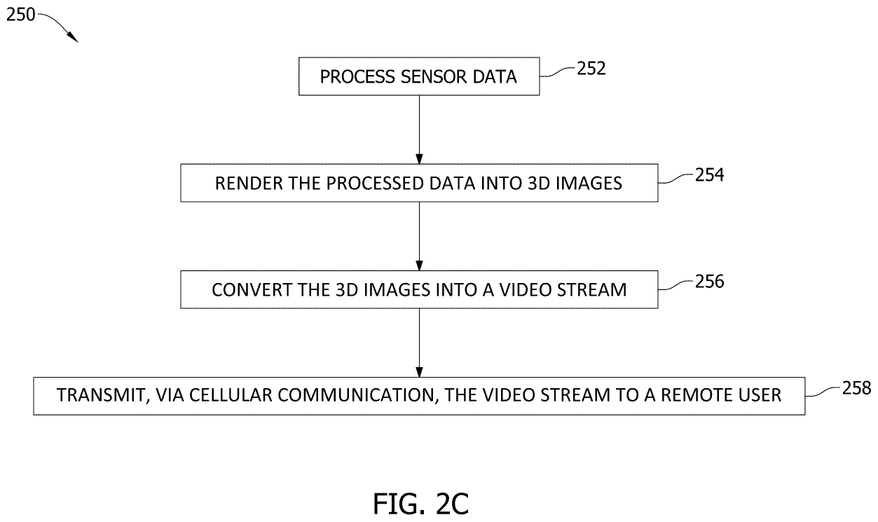

FIGS. 2A-2C show an exemplary autonomous vehicle 102 configured to provide remote dynamic situation visualization. FIG. 2A shows an example visualization system 200. FIG. 2B is a block diagram of visualization system 200. FIG. 2C is a flow chart of an example method 250 of providing remote dynamic visualization of situations.

In the exemplary embodiment, visualization system 200 includes autonomous vehicle 102. Autonomous driving computing device 104 of autonomous vehicle 102 is configured to process sensor data from sensors 109 and provide visualization of situations around autonomous vehicle 102. The visualization is a 3D rendering. 3D rendering may be based on LiDAR data and/or other sensor data. The processing of sensor data, especially LiDAR 3D rendering, consume significant computing capacity of a computing device, limiting the types of computing devices that can effectively process and 3D render sensor data.

In the exemplary embodiment, visualization system 200 includes a remote visualization application 204. Remote visualization application 204 is accessible at a remote computing device 206. Remote visualization application 204 may be stored in one or more non-transitory machine-readable storage media. Remote user 208 may access the remote visualization application 204 through the Internet as a web-based application or an app that can be downloaded on a wireless device such as a cellular phone or a tablet. Alternatively, remote visualization application 204 is a program that can be installed on remote computing device 206. Remote visualization application 204 enables remote user 208 to enter controls and/or manipulate the rendering and visualization. For example, remote visualization application 204 includes functions or options for remote user 208 to change the views and/or change the data sources. Example manipulation functions may include translation, zooming in and/or out, panning such as swiveling the views, rotating or tilting such as changing the angles of the views, changing the orientation of views such as front or perspective views or the types of views such as shaded or transparent views, changing the selection of data sources such as adding or removing data from radar system 132.

In the exemplary embodiment, remote user 208 is provided with an access to autonomous driving computing device 104, where remote user 208 is provided with options to control the visualization of the video stream. Remote user 208 is provided with the capability to manipulate the rendering and visualization parameters via the user's remote visualization application, thereby facilitating remote user 208 to change the rendered sources and resulting video stream. The task of processing the large amount of sensor data and 3D-rendering, which requires relatively large and fast computation power, is performed by autonomous driving computing device 104, thereby providing the flexibility and responsiveness in remotely manipulating the rendering and visualization, which is prevented by the limited cellular bandwidth in known methods.

In the exemplary embodiments, visualization system 200 does not place a limit on computation power and/or speed of remote computing device 206. Remote computing device may be a wireless device or a computing device having a relatively low computation power, memory, and/or speed. The computation-heavy part of data processing, such as calculation, presentation, preparation, perception, and rendering, is performed by autonomous driving computing device 104, where sensor data are located. As a result, the limitation from transmission bandwidth and computing power of remote computing device 206 is obviated. Remote user 208 may manipulate the video streams as if remote user 208 is in tractor 105. Remote user 208 may also control how the data is processed. For example, if remote user 208 wants a different piece information or angle, visualization system 200 provides the options to select data sources by selecting types of sensors, groups of sensors, and/or sensors at a certain location of autonomous vehicle 102. In some embodiments, remote user 208 is provided with an option of saving the configuration as a default setting, thereby increasing the efficiency in adjusting the manipulation and visualization. In some embodiments, autonomous vehicle 102 may include a plurality of cellular modems, such as three cellular modems, to increase the cellular bandwidth. In other embodiments, autonomous vehicle 102 may include one or more satellite modems or include both cellular modems and satellite modems.

Referring to FIG. 2C, in the example embodiment, method 250 may be implemented on autonomous driving computing device 104. Method 250 includes processing 252 sensor data from sensors. Method 250 also includes rendering 254 the processed sensor data into 3D images. Method 250 further includes converting 256 the 3D images into a video stream. In addition, method 250 includes transmitting 258, via cellular communication, the video stream to a remote user. Visualization of sensor data may be manipulated by a remote user. The manipulation and visualization parameters from remote user 208 may be entered in remote visualization application 204 and transmitted to autonomous driving computing device 104 via cellular communication (see FIGS. 2A and 2B). Autonomous driving computing device 104 is configured to adjust the video stream based on the manipulation and visualization parameters, and transmit the adjusted video stream to remote user 208. Remote user 208 and autonomous driving computing device 104 communicate with one another via remote visualization application 204. Manipulation and visualization parameters are entered by remote user 208 in remote visualization application 204, and video stream 210 is sent from autonomous driving computing device 104 to remote visualization application 204. Autonomous driving computing device 104 communicates with remote visualization application 204 through cellular communication (see FIGS. 2A and 2B).

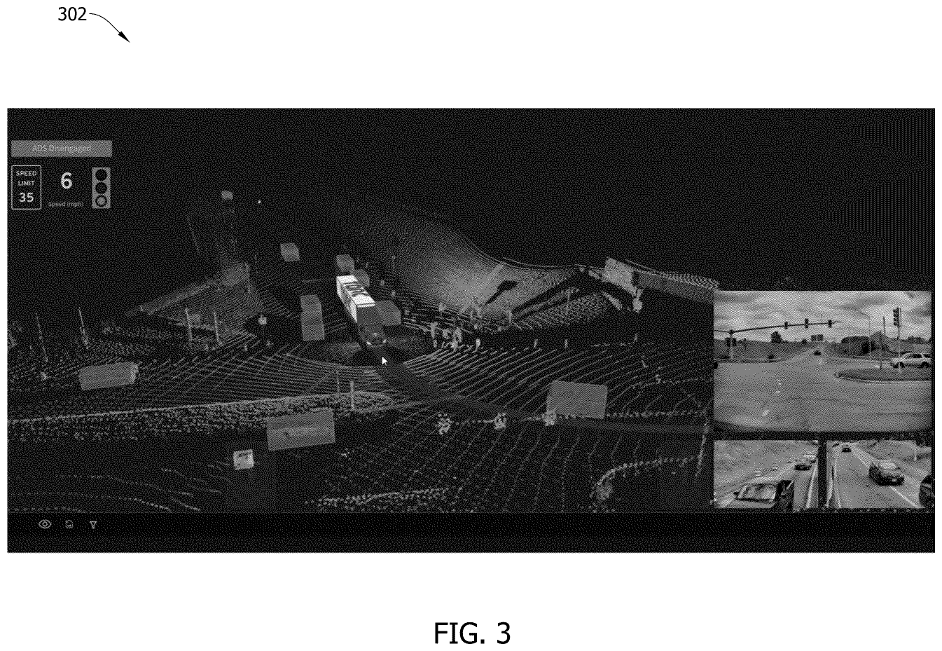

FIG. 3 is screenshot 302 of a video stream produced by system 136 and received by remote user 208. Video stream 210 of the rendered 3D volume is displayed, besides images from camera system 120. Remote user 208 may manipulate the rendering and visualization provided at the user's end. The controls, or the manipulation and visualization parameters, entered by remote user 208 are transmitted via the Internet and/or wireless communication such as cellular communication. Once received, the controls, autonomous driving computing device 104 changes the rendering and visualization, convert the changed 3D-rendered images into video streams, and transmit the video streams to remote user 208 over the Internet and/or wireless communication.

Systems and methods described herein are advantageous in supporting use cases that facilitate a remote user, a user not in the vehicle, to see in near real-time what autonomous vehicle 102 sensed, such as data from cameras, LiDAR, radar, perception, and other inputs.

Systems and methods described herein are advantageous in facilitating remote assistance and increasing the effectiveness in remote assistance. A remote user 208 is provided with remote manipulation of the rendering and visualization such that remote user 208 has an increased contextual or situational understanding of the situation of autonomous vehicle 102. For example, autonomous vehicle 102 detects an obstacle on the road and seek assistance from remote user 208 in determining the travel trajectory. The obstacle may not be present in the original views or not depicted with sufficient details in the original views for remote user 208 to provide assistance. Remote user 208 may manipulate the rendering and visualization parameters using the user's remote visualization application to locate the obstacle and/or zoom in or out to adjust the visualization of the obstacle and the situation to a user-desired level, thereby increasing the effectiveness of remotely assisting autonomous vehicle 102 in choosing the travel trajectory. As a result, operational efficiency of autonomous vehicle 102 is increased.

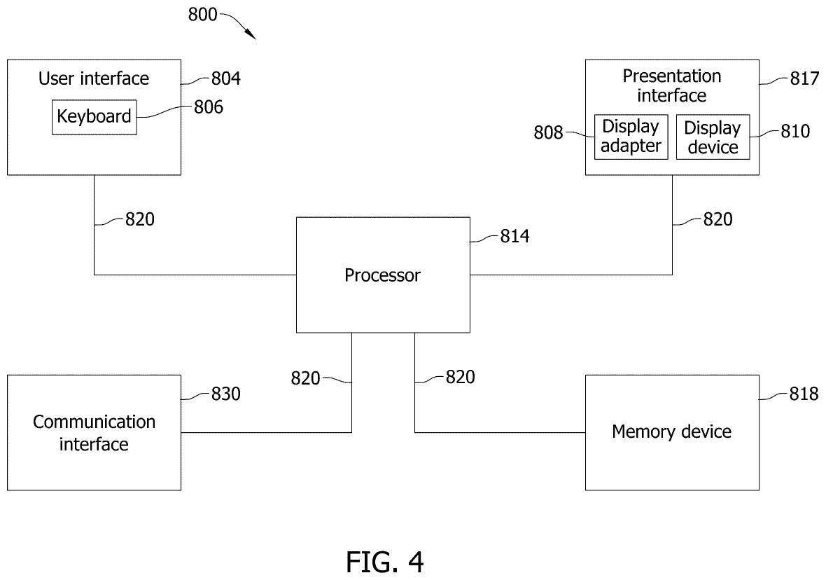

Methods described herein may be implemented on autonomous driving computing device 104. Autonomous driving computing device 104 described herein may be any suitable computing device 800 and software implemented therein. FIG. 4 is a block diagram of an example computing device 800. Computing device 800 includes a processor 814 and a memory device 818. Processor 814 is coupled to user interface 804, presentation interface 817, and memory device 818 via a system bus 820. In the example embodiment, processor 814 communicates with the user, such as by prompting the user via presentation interface 817 and/or by receiving user inputs via user interface 804. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition and/or meaning of the term “processor.”

In the example embodiment, memory device 818 includes one or more devices that enable information, such as executable instructions and/or other data, to be stored and retrieved. Moreover, memory device 818 includes one or more computer readable media, such as, without limitation, dynamic random access memory (DRAM), static random access memory (SRAM), a solid state disk, and/or a hard disk. In the example embodiment, memory device 818 stores, without limitation, application source code, application object code, configuration data, additional input events, application states, assertion statements, validation results, and/or any other type of data. Computing device 800, in the example embodiment, may also include a communication interface 830 that is coupled to processor 814 via system bus 820. Moreover, communication interface 830 is communicatively coupled to data acquisition devices.

In the example embodiment, processor 814 may be programmed by encoding an operation using one or more executable instructions and providing the executable instructions in memory device 818. In the example embodiment, processor 814 is programmed to select a plurality of measurements that are received from data acquisition devices.

In operation, a computer executes computer-executable instructions embodied in one or more computer-executable components stored on one or more computer-readable media to implement aspects of the invention described and/or illustrated herein. The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In certain embodiments, computing device 800 includes a user interface 804 that receives at least one input from a user. User interface 804 may include a keyboard 806 that enables the user to input pertinent information. User interface 804 may also include, for example, a pointing device, a mouse, a stylus, a touch sensitive panel (e.g., a touch pad and a touch screen), a gyroscope, an accelerometer, a position detector, and/or an audio input interface (e.g., including a microphone).

Moreover, in the example embodiment, computing device 800 includes a presentation interface 817 that presents information, such as input events and/or validation results, to the user. Presentation interface 817 may also include a display adapter 808 that is coupled to at least one display device 810. More specifically, in the example embodiment, display device 810 may be a visual display device, such as a cathode ray tube (CRT), a liquid crystal display (LCD), a light-emitting diode (LED) display, and/or an “electronic ink” display. Alternatively, presentation interface 817 may include an audio output device (e.g., an audio adapter and/or a speaker) and/or a printer.

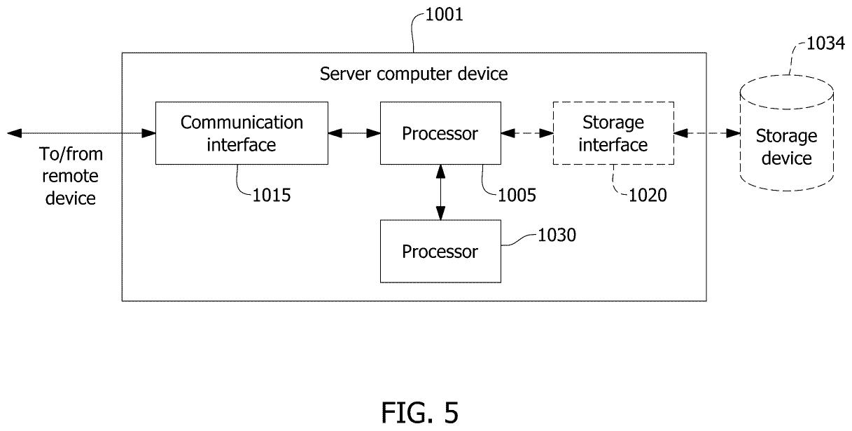

FIG. 5 illustrates an example configuration of a server computer device 1001 such as mission control computing device 125. Server computer device 1001 also includes a processor 1005 for executing instructions. Instructions may be stored in a memory area 1030, for example. Processor 1005 may include one or more processing units (e.g., in a multi-core configuration).

Processor 1005 is operatively coupled to a communication interface 1015 such that server computer device 1001 is capable of communicating with a remote device or another server computer device 1001. For example, communication interface 1015 may receive data from autonomous driving computing device 104 or sensors 109, via the Internet or wireless communication.

Processor 1005 may also be operatively coupled to a storage device 1034. Storage device 1034 is any computer-operated hardware suitable for storing and/or retrieving data. In some embodiments, storage device 1034 is integrated in server computer device 1001. For example, server computer device 1001 may include one or more hard disk drives as storage device 1034. In other embodiments, storage device 1034 is external to server computer device 1001 and may be accessed by a plurality of server computer devices 1001. For example, storage device 1034 may include multiple storage units such as hard disks and/or solid state disks in a redundant array of independent disks (RAID) configuration. storage device 1034 may include a storage area network (SAN) and/or a network attached storage (NAS) system.

In some embodiments, processor 1005 is operatively coupled to storage device 1034 via a storage interface 1020. Storage interface 1020 is any component capable of providing processor 1005 with access to storage device 1034. Storage interface 1020 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 1005 with access to storage device 1034.

An example technical effect of the methods, systems, and apparatus described herein includes at least one of: (a) providing remote visualization of a situation of an autonomous vehicle; or (b) facilitating a remote user to adjust manipulation and visualization parameters.

Some embodiments involve the use of one or more electronic processing or computing devices. As used herein, the terms “processor” and “computer” and related terms, e.g., “processing device,” “computing device,” and “controller” are not limited to just those integrated circuits referred to in the art as a computer, but broadly refers to a processors, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

In the embodiments described herein, memory may include, but is not limited to, a non-transitory computer-readable medium or a non-transitory machine-readable storage medium, such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable, and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomous vehicle, comprising:
one or more sensors; and
an autonomous driving computing device, comprising at least one processor in communication with at least one memory device, and the at least one processor programmed to:
process sensor data received from the one or more sensors;
render the processed sensor data into 3D images;
convert the 3D images into a video stream; and
transmit, via mobile communication, the video stream to a remote user.

2. The autonomous vehicle of claim 1, wherein the at least one processor is further programmed to:
render the processed sensor data by:
receiving manipulation and visualization parameters of rendering from the remote user; and
adjusting 3D rendering based on the manipulation and visualization parameters.

3. The autonomous vehicle of claim 2, wherein the at least one processor is further programmed to:
convert adjusted 3D images into the video stream; and
transmit the video stream of the adjusted 3D images to the remote user.

4. The autonomous vehicle of claim 2, wherein the at least one processor is further programmed to:
receive the manipulation and visualization parameters including zooming.

5. The autonomous vehicle of claim 2, wherein the at least one processor is further programmed to:
receive the manipulation and visualization parameters including panning.

6. The autonomous vehicle of claim 2, wherein the at least one processor is further programmed to:
receive the manipulation and visualization parameters including tilting.

7. The autonomous vehicle of claim 2, wherein the at least one processor is further programmed to:
receive the manipulation and visualization parameters including changing a source of the sensor data.

8. An autonomous driving computing device of an autonomous vehicle, comprising at least one processor in communication with at least one memory device, and the at least one processor programmed to:
process sensor data received from one or more sensors of an autonomous vehicle;
render the processed sensor data into 3D images;
convert the 3D images into a video stream; and
transmit, via mobile communication, the video stream to a remote user.

9. The autonomous driving computing device of claim 8, wherein the at least one processor is further programmed to:
render the processed sensor data by:
receiving manipulation and visualization parameters of rendering from the remote user; and
adjusting 3D rendering based on the manipulation and visualization parameters.

10. The autonomous driving computing device of claim 9, wherein the at least one processor is further programmed to:
convert adjusted 3D images into the video stream; and
transmit the video stream of the adjusted 3D images to the remote user.

11. The autonomous driving computing device of claim 9, wherein the at least one processor is further programmed to:
receive the manipulation and visualization parameters including zooming.

12. The autonomous driving computing device of claim 9, wherein the at least one processor is further programmed to:
receive the manipulation and visualization parameters including panning.

13. The autonomous driving computing device of claim 9, wherein the at least one processor is further programmed to:
receive the manipulation and visualization parameters including tilting.

14. The autonomous driving computing device of claim 9, wherein the at least one processor is further programmed to:
receive the manipulation and visualization parameters including changing a source of the sensor data.

15. One or more non-transitory machine-readable storage media for manipulating visualization of sensor data of an autonomous vehicle, comprising a plurality of instructions stored thereon that, in response to being executed, cause a system to:
receive, via mobile communication, a video stream sent from an autonomous vehicle, wherein the video stream is generated by:
processing sensor data received from one or more sensors of the autonomous vehicle;
rendering the processed sensor data into 3D images; and
converting the 3D images into the video stream.

16. The one or more non-transitory machine-readable storage media of claim 15, wherein the plurality of instructions further cause the system to:
receive manipulation and visualization parameters of rendering from a remote user; and
transmit the manipulation and visualization parameters to the autonomous vehicle, wherein the autonomous vehicle is configured to adjust 3D rendering based on the manipulation and visualization parameters.

17. The one or more non-transitory machine-readable storage media of claim 16, wherein the plurality of instructions further cause the system to:
receive an adjusted video stream from the autonomous vehicle, wherein the adjusted video stream is generated by:
converting adjusted 3D images into the adjusted video stream.

18. The one or more non-transitory machine-readable storage media of claim 16, wherein the plurality of instructions further cause the system to:
receive the manipulation and visualization parameters including zooming and/or panning.

19. The one or more non-transitory machine-readable storage media of claim 16, wherein the plurality of instructions further cause the system to:
receive the manipulation and visualization parameters including tilting.

20. The one or more non-transitory machine-readable storage media of claim 16, wherein the plurality of instructions further cause the system to:
receive the manipulation and visualization parameters including changing a source of the sensor data.
